(19) United States
(12) Patent Application Publication
(10) Pub. No.: US 2026/0350569 A1
(43) Pub. Date: Nov. 5, 2026

(54) INTERLINKING NFT STRUCTURE WITH MUTABILITY PROPERTIES

(71) Applicant: Wells Fargo Bank, N.A., San Francisco, CA (US)

(72) Inventors: Debashis Ghosh, San Francisco, CA (US); Luiz Fernando Flor de Silva, Pleasant Hill, CA (US); Nathaniel C. Eutsler, San Francisco, CA (US); Matthew Mullin Shepherd, Charlotte, NC (US)

(73) Assignee: Wells Fargo Bank, N.A., San Francisco, CA (US)

(21) Appl. No.: 18/101,380

(22) Filed: Jan. 25, 2023

(51) Int. Cl. G06Q 20/12; G06Q 20/38

(52) U.S. Cl. CPC G06Q 20/12; G06Q 20/3829

(57) ABSTRACT

Aspects of this technical solution can include receiving, by an NFT transaction processor, a request to generate an NFT corresponding to a physical object, identifying, by a content processor, a first property of the physical object indicating that a first physical feature of the physical object is immutable, identifying, by the content processor, a second property of the physical object indicating that a second physical feature of the physical object is mutable, and generating, by the NFT transaction processor, an NFT including a first parameter based on the first property of the physical object, a second parameter based on the second property of the physical object, and a link with a public and private key pair of an NFT account.

### TECHNICAL FIELD

The present implementations relate generally to electronic networks, and more particularly to an interlinking structure with mutability properties for a non-fungible token (NFT).

### INTRODUCTION

The number any type of transactions conducted on networks is increasing in volume and complexity. Digital assets are increasingly expects to correspond to real-world analogs with increasing accuracy and responsiveness. However, conventional systems cannot identify characteristics for real-world analogs, cannot accurately generate values in view of those characteristics, and cannot effectively execute transactions involving various digital assets.

### SUMMARY

Aspects of this technical solution are directed to identifying mutability properties corresponding to a particular physical object, and generating or modifying an NFT to include or reference one or more mutability properties. For example, a mutability property can include one or more of an immutable property and an mutable property. An immutable property can correspond to a static aspect of a physical object, such that any change to the immutable property results in a material change to the physical object. For example, an immutable property can correspond to a property line or plot definition of real property, such that any change to the property line materially changes the real property. A mutable property can correspond to an ephemeral aspect of a physical object, such that various changes to the immutable property can various results in a material change to the physical object or a immaterial change to the physical object. For example, a mutable property can correspond to an improvement of real property including a dwelling, such that a change to the dwelling within a particular threshold of change results in an immaterial change to the property.

This technical solution can mint, generate, or modify an NFT in response to a determination that a material change to a physical property has occurred. The technical solution can obtain one or more characteristics corresponding to physical properties of a physical object corresponding to particular times, and can determine whether the physical properties of a physical object corresponding to particular times indicate a material or immaterial change to the physical object. For example, the technical solution can be configured to be compatible with or interoperable with an external system that tracks state or status of various physical objects. The technical solution can mint, generate, or modify an NFT to include one or more links to one or more NFTs based on physical properties of a physical object or links or correspondences between physical objects. This technical solution includes but is not limited to physical objects, and can be drawn to physical objects, non-physical objects, or any combination thereof. Thus, a technological solution for an interlinking structure with mutability properties for an NFT is provided.

At least one aspect is directed to a method to maintain a non-fungible token (NFT) based on an object, the method can include receiving, by an NFT transaction processor, a request to generate an NFT corresponding to a physical object. The method can include identifying, by a content processor, a first property of the physical object indicating that a first physical feature of the physical object is immutable. The method can include identifying, by the content processor, a second property of the physical object indicating that a second physical feature of the physical object is mutable. The method can include generating, by the NFT transaction processor, an NFT can include a first parameter based on the first property of the physical object, a second parameter based on the second property of the physical object, and a link with a public and private key pair of an NFT account.

At least one aspect is directed to a system to maintain a non-fungible token (NFT) based on an object. The system can include memory and one or more processors. The system can receive, by an NFT transaction processor, a request to generate an NFT corresponding to a physical object. The system can identify, by a content processor, a first property of the physical object indicating that a first physical feature of the physical object is immutable. The system can identify, by the content processor, a second property of the physical object indicating that a second physical feature of the physical object is mutable. The system can generate, by the NFT transaction processor, an NFT can include a first parameter based on the first property of the physical object, a second parameter based on the second property of the physical object, and a link with a public and private key pair of an NFT account.

At least one aspect is directed to a computer readable medium can include one or more instructions stored thereon and executable by a processor. The processor can receive a request to generate an FT corresponding to a physical object. The processor can identify a first property of the physical object indicating that a first physical feature of the physical object is immutable. The processor can identify a second property of the physical object indicating that a second physical feature of the physical object is mutable. The processor can generate an FT can include a first parameter based on the first property of the physical object, a second parameter based on the second property of the physical object, and a link with a public and private key pair of an NFT account.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 depicts an example system, in accordance with present implementations.

FIG. 2 depicts an example system architecture, in accordance with present implementations.

FIG. 3 depicts an example system architecture, in accordance with present implementations.

FIG. 4 depicts an example wallet container architecture, in accordance with present implementations.

FIG. 5 depicts an example NFT transaction processor architecture, in accordance with present implementations.

FIG. 6 depicts an example NFT architecture, in accordance with present implementations.

FIG. 7 depicts an example NFT nest architecture, in accordance with present implementations.

FIG. 8 depicts an example method of generating NFT corresponding to one or more properties, in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

NFT transfer processes can include multiple validation and authentication layers. However, various validation and authentication layers can potentially reduce transfer speeds and thus reduce effectiveness of NFTs as a transfer medium or transaction medium. Further, NFTs are part of an increasingly diverse transfer and transaction network environment, and interoperability in transfer infrastructure of NFTs with other types and classes of system objects is of increasing importance. NFT transfer processes can include multiple validation and authentication layers. However, various validation and authentication layers can potentially reduce transfer speeds and thus reduce effectiveness of NFTs as a transfer medium or transaction medium. Further, NFTs are part of an increasingly diverse transfer and transaction network environment, and interoperability in transfer infrastructure of NFTs with other types and classes of system objects is of increasing importance.

Aspects of this technical solution are directed to minting, generating, or modifying an NFT having one or more of a link, an immutable property, and a mutable property. Aspects of this technical solution can include a system to mint, generate or modify an NFT based on one or more immutable or mutable properties corresponding to an object external to the NFT. For example, a system can interact with an external system or a processor integrated with the system to obtain a token corresponding to an object or a property of an object. The token can include or reference a property of an object or a change in a property of an object. The system can determine a type of the property and a type of the change, and can mint, generate or modify an NFT based on one or more of the type of the property and the type of the change. The system can link one or more NFTs to correspond to links, references, or relationships between various physical object, non-physical objects, or any combination thereof. For example, a physical object can correspond to a vehicle, and a non-physical object can correspond to a data structure or transaction operation for a lien corresponding to the vehicle.

The system can mint, generate, modify or destroy NFTs based on one or more properties or changes to properties. For example, the system can destroy an NFT upon detection of a material change corresponding to one or more of an immutable property and a mutable property, and can mint or generate a descendant NFT based on one or more of an immutable property and a mutable property including or corresponding to the material change. For example, the system can destroy an NFT corresponding to real property in response to a material change to a boundary of the real property, and can mint or generate a descendant NFT having an immutable property corresponding to the changed boundary. The system can generate, modify or destroy one or more wallet containers corresponding to particular accounts or entities linked with or controlling the NFT or the object corresponding to the NFT. The system can, in response to a determination or detection of change to an account or entity linked with or controlling the NFT or the object corresponding to the NFT, transfer one or more NFTs between a first wallet container and a second wallet container, and can generate or destroy one or more wallet containers. For example, a wallet container can identify a beneficiary vi a link with a wallet container controlled by the beneficiary, and can transfer contents of the wallet container to the wallet container of the beneficiary in response to a detection or determination that an event triggering the transfer has occurred.

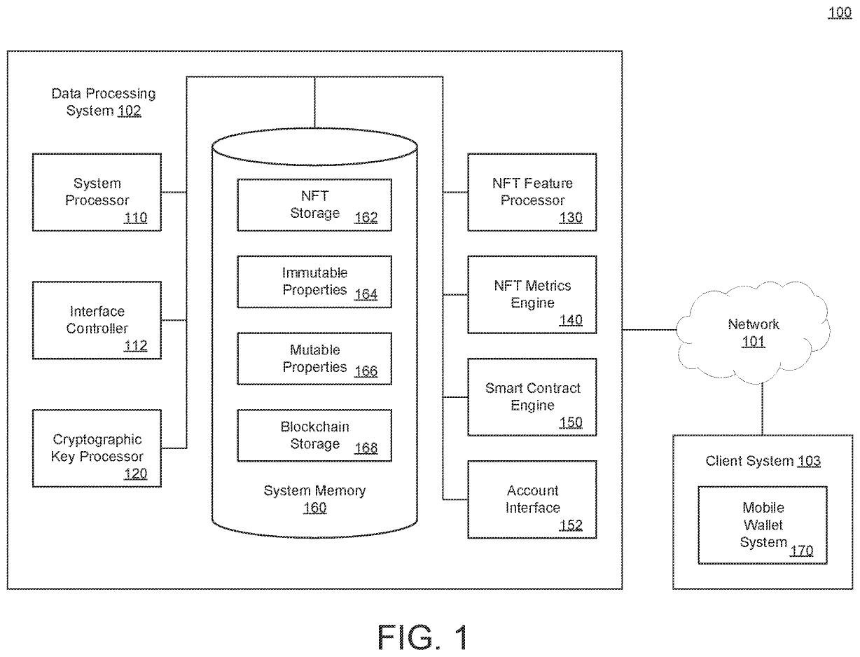

FIG. 1 depicts an example system, in accordance with present implementations. As illustrated by way of example in FIG. 1, an example system 100 can include at least a network 101, a data processing system 102, a client system 103, and a trust system 104.

The network 101 can include any type or form of network. The geographical scope of the network 101 can vary widely and the network 101 can include a body area network (BAN), a personal area network (PAN), a local-area network (LAN), e.g. Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SD (Synchronous Digital Hierarchy) protocol. The ‘TCP/IP internet protocol suite can include application layer, transport layer, internet layer (including, e.g., IPv6), or the link layer. The network 101 can include a type of a broadcast network, a telecommunications network, a data communication network, or a computer network.

The data processing system 102 can include a physical computer system operatively coupled or that can be coupled with one or more components of the system 100, either directly or directly through an intermediate computing device or system. The data processing system 102 can include a virtual computing system, an operating system, and a communication bus to effect communication and processing. The data processing system 102 can include a system processor 110, an interface controller 112, a cryptographic key processor 120, an NFT feature processor 130, an NFT metrics engine 140, a smart contract engine 150, an account interface 152, and a system memory 160.

The system processor 110 can execute one or more instructions associated with the system 100. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The system processor 110 or the system 100 generally can include one or more communication bus controller to effect communication between the system processor 110 and the other elements of the system 100.

The interface controller 112 can link the data processing system 102 with one or more of the network 101, the client system 103, and the account system 104, by one or more communication interfaces. A communication interface can include, for example, an application programming interface (“API”) compatible with a particular component of the data processing system 102, the client system 103, or the account system 104. The communication interface can provide a particular communication protocol compatible with a particular component of the data processing system 102 and a particular component of the client system 103 or the account system 104. The interface controller 112 can be compatible with particular content objects, and can be compatible with particular content delivery systems corresponding to particular content objects. For example, the interface controller 112 can be compatible with transmission of video content, audio content, or any combination thereof. For example, the interface controller 112 can be compatible with payment processing transmissions by a protocol compatible with payment processing latency and encryption structures.

The cryptographic key processor 120 can generate and modify cryptographic keys. For example, the cryptographic key processor 120 can include one or more asymmetric or symmetric key generators, and can generate public-private key pairs. For example, a public-private key pair can include a public key configured to encrypt in accordance with a particular transform process. For example, a public-private key pair can include a private key configured to decrypt in accordance with a particular transform process compatible with the public key. The cryptographic key processor 120 can link the public-private key pair with any individual object or component. The cryptographic key processor 120 can link any public key or private key corresponding to the public-private key pair with any individual object or component. For example, the cryptographic key processor 120 can generate a key compatible with or linked with a particular identifier corresponding to a particular, device, user, customer, account, system, or any combination thereof.

The NFT feature processor 130 can identify one or more characteristics of one or more NFTs. For example, the feature processor 130 can identify one or more characteristics of an individual NFT or a plurality of NFTs satisfying one or more criteria. The NFT feature processor 130 can generate a particular feature corresponding to one or more characteristics of an NFT or an object linked with the NFT. For example, a feature can include a scalar or vector quantity corresponding to one or more vales of an aspect of an NFT. For example, a feature can include a list of coordinates corresponding to a line identified in an image linked with an NFT. For example, a feature can include a numeric value corresponding to an identifier of an NFT. For example, criteria by which NFTs can be identified can include aspects of the NFT, fields or components of the NFT, transform processes used to generate or modify the NFT, aspects of a content object linked with the NFT, or any combination thereof. For example, aspects of the NFT can include a hash of the NFT, or a value of an individual field of the NFT. For example, aspects of the NFT can include a hash of the NFT, or a value of an individual field of the NFT. For example, aspects of a content object linked with the NFT can include a bitmap of an image linked with the NFT, or a hash of a media content linked with the NFT. Media content can include images, audio, three-dimensional (3D) models, or any combination thereof.

The NFT metrics engine 140 can generate and modify one or more metrics based on one or more NFTs. For example, the NFT metrics engine 140 can generate a metric based one or more features obtained from the NFT feature processor 130. For example, the NFT metrics engine 140 can generate a metric to indicate a particular value or type of a particular NFT. The NFT metrics engine 140 can generate metrics compatible with particular thresholds. For example, the thresholds can activate particular transforms of an aspect of an NFT, feature or metric. For example, the thresholds can execute one or more instructions corresponding to a particular NFT or type of NFT, type of object linked an NFT, or any combination thereof. For example, the NFT metrics engine 140 can determine that a particular metric having a particular value and based on a type of an NFT satisfies a threshold that indicates a particular value compatible with the particular value of the metric.

The smart contract engine 150 can generate and modify one or more smart contracts. The smart contract engine 150 can execute instructions to generate or modify a cryptographic container, to add or remove objects from a cryptographic container, and to execute various processors linked with or embedded with a smart contract. For example, the smart contract engine 150 can execute various processors of a smart contract in response to an indication from the NFT metrics engine 140 that a metric satisfies a particular threshold. For example, the smart contract engine 150 can execute various processors of a smart contract in response to detecting input including or corresponding to a particular token at the smart contract. For example, the smart contract engine 150 can include processors to read, write, generate, or modify one or more objects contained within a container of the smart contract, one or more tokens input to the smart contract, or one or more processors of the smart contract.

The account interface 152 can communicate with one or more external systems compatible with allocating an NFT. For example, the account interface 152 can include an application programming interface (API) compatible with the account system 104 and the interface controller 112. For example, the account interface 152 can be configured to receive characteristics associated with particular NFTs, accounts, or content objects linked with particular NFTs. For example, the account interface 152 can be configured to receive identifiers corresponding to various NFTs linked with a particular account, account control instructions, currency or asset transfer instruction, or any combination thereof. The account interface 152 can thus provide the technical improvement of detecting and transmitting metrics generated to allocate an NFT between storage locations or blockchain locations. The account interface 152 can provide the technical improvement of providing a communication interface compatible with particular NFT transfer operations.

The system memory 160 can store data associated with the system 100. The system memory 160 can include one or more hardware memory devices to store binary data, digital data, or the like. The system memory 160 can include one or more electrical components, electronic components, programmable electronic components, reprogrammable electronic components, integrated circuits, semiconductor devices, flip flops, arithmetic units, or the like. The system memory 160 can include at least one of a non-volatile memory device, a solid-state memory device, a flash memory device, and a NAND memory device. The system memory 160 can include one or more addressable memory regions disposed on one or more physical memory arrays. A physical memory array can include a NAND gate array disposed on, for example, at least one of a particular semiconductor device, integrated circuit device, and printed circuit board device. The system memory 160 can include an NFT storage 162, a key storage 164, a smart contract storage 166, and a blockchain storage 168.

The NFT storage 162 can include NFTs associated with the data processing system 102 or any component thereof, the client system 103 or any component thereof, any content object, or any combination thereof. The key storage 164 can store cryptographic keys associated with the data processing system 102 or any component thereof, the client system 103 or any component thereof, any content object, or any combination thereof. For example, the key storage 164 can include public-private key pairs or private keys corresponding to particular accounts, NFTs, smart contracts, devices, users, systems, or any combination thereof. The smart contract storage 166 can store one or more smart contracts and corresponding addresses for particular smart contracts that indicate links with the corresponding smart contracts. The blockchain storage 168 can store one or more blockchains linked to one or more smart contracts, tokens, containers, or content objects, by corresponding addresses for particular smart contracts, tokens, containers, or content objects that indicate links with a particular blockchain.

The client system 103 can include a computing system located remotely from the data processing system 102. The client system 103 can include a mobile wallet system 170. The mobile wallet system 170 can include an interface to execute instructions corresponding to a particular wallet account, and to modify the structure or contents of a particular smart contract corresponding to a wallet account. For example, the mobile wallet system 170 can include a user interface to receive input that indicates selections of various NFTs, transactions, accounts, devices, users, or systems. For example, the user interface can include a graphical user interface that can be presented at a display device. The display device can display at least one or more user interface presentations, and can include an electronic display. An electronic display can include, for example, a liquid crystal display (LCD), a light-emitting diode (LED) display, an organic light-emitting diode (OLED) display, or the like. The display device can receive, for example, capacitive or resistive touch input. The mobile wallet system 170 can transmit one or more instructions, tokens, keys, or any combination thereof to, from, or with the data processing system 102.

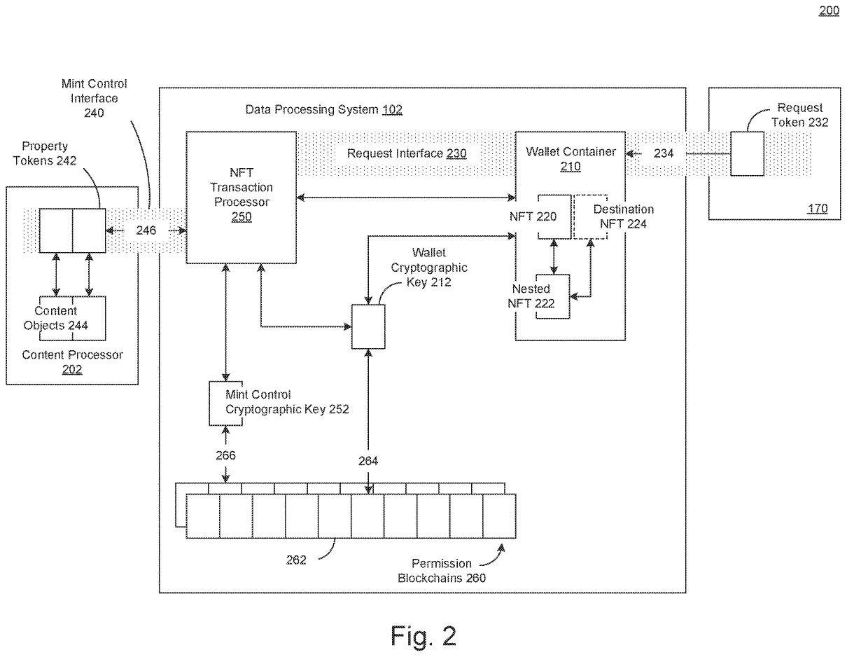

FIG. 2 depicts an example system architecture, in accordance with present implementations. As illustrated by way of example in FIG. 2, an example system architecture 200 can include at least a content processor 202, a wallet container 210, a wallet cryptographic key 212, a request interface 230, a mint control interface 240, an NFT transaction processor 250, a mint control cryptographic key 252, and a permission blockchain 260.

The content processor 202 can execute one or more actions in response to communication via one or more interfaces. The content processor 202 can, for example, receive output from particular content objects and can generate or obtain one or more property tokens 242 based on the content objects 244. The content processor 202 can be at least partially col-located or integrated with the data processing system 102, or can be located remotely from the data processing system 102. The content processor 202 can include one or more property tokens 242, and one or more content objects 244. For example, the content processor can correspond to or link with a commercial or government database system, and can include at least one application programming interface (“API”) configured to include an encryption layer restricted to the mobile wallet system 170. For example, the system can include processors to detect, by the content processor and based on a feature corresponding to the physical object, the modification of the second property of the physical object. For example, the system can include processors to identify, by the content processor, the first property of the second physical object indicating that a first physical feature of the second physical object is immutable. The system can identify, by the content processor, the second property of the second physical object indicating that a second physical feature of the second physical object is mutable.

The property tokens 242 can identify a content object or corresponding aspects of the content objects 244. For example, the property tokens 242 can include an immutable property of a content object 244, a immutable property of a content object 244, or any combination thereof. The content processor 202 can obtain a property token 242 from a content object 244, or can generate a property token 242 based on a content object 244. For example, the content processor 202 can obtain a field of a content object 244 corresponding to a boundary definition of a real property title record, and can generate a property token 242 based on the field. The content processor 202 can obtain or generate various property token 242 in response to detection of a change in a mutable property or immutable property of one or more specified content objects 244. The content processor 202 can detect of a change in a mutable property or immutable property of one or more specified content objects 244. The content objects 244 can correspond to physical or non-physical objects. For example, a content objects 244 can correspond to an aspect of a physical object or a non-physical object. For example, an aspect can include a photo, a blueprint, a computer-aided design (CAD) drawing, one or more quantitative values, one or more qualitative values, or any combination thereof.

The wallet container 210 can include one or more NFTs linked with a particular user or device. For example, the wallet container 210 can encapsulate one or more NFTs linked with a particular user within a secure container, and can include an interface compatible with the NFT transaction processor 250, the client system 103, and the content processor 202. The wallet container 210 can include an NFT 220, a nested NFT 222, and a destination NFT 224. The wallet cryptographic key 212 can include a key compatible with the wallet container 210. The wallet container 210 can execute a transaction or modify contents of the wallet container 210 in response to detecting input including the wallet cryptographic key 214. The wallet cryptographic key 214 can, for example, include a public-private key pair, a public key, or a private key compatible with the wallet container 210. The wallet container 210 can permit access to the wallet NFTs 212 based on the wallet cryptographic key 214, for example, compatible with the encapsulation layer and operable to decrypt the encryption corresponding to the encapsulation layer.

The NFT 220 can correspond to a particular content object, physical object, or non-physical object, or any combination thereof. The NFT 220 can have a structure including one or more of an immutable property, a mutable property, and a link, or any combination thereof. The NFT 220 can link with or be configured to link with the nested NFT 222 via the link of the NFT 220 or a corresponding link of the nested NFT 220. The nested NFT 222 can correspond at least partially in one or more of structure and operation to the NFT 220. The nested NFT 222 can correspond to a particular content object, physical object, or non-physical object, or any combination thereof distinct from that of the NFT 220. For example, the NFT 220 can correspond to a content object or a physical object identifying real property, and the nested NFT 220 can correspond to a content object or a non-physical object identifying parameters of a mortgage linked with the real property.

The destination NFT 224 can correspond at least partially in one or more of structure and operation to the NFT 220. For example, the wallet container 210 can obtain the destination NFT 224 in response to an operation by the content processor 202 or the NFT transaction processor 250 to mint or generate the destination NFT 224. The destination NFT 224 can have one or more of a link, an immutable property, and a mutable property corresponding to the NFT 220, or one or more of a link, an immutable property, and a mutable property distinct from the NFT 220. For example, the destination NFT 224 can have an immutable property incorporating a change to an immutable property of the NFT 220, in response to a detection by the content processor 202 or the NFT transaction processor 250 of a change in an immutable property of the NFT 220.

The request interface 230 can include a communication channel between one or more of the wallet container 210 and the NFT transaction processor 250. The request interface 230 can include an application programming interface compatible with the wallet container 210 to detect the request token 232 at the client system 103. The request interface 230 can include a request token 232, and a request communication 234. The request token 232 can identify an NFT and can identify one or more characteristics linked with the NFT or corresponding to a request to obtain a parameter corresponding to the NFT or a content object 244 linked with the NFT. For example, the request token 232 can include request to obtain one or more aspects of a physical object or a non-physical object from the content processor 202. The request communication 234 can transmit the request token 232 from the client system 103 to the data processing system 102 or the wallet container 210.

The mint control interface 240 can include a communication channel between the content processor 202 and the NFT transaction processor 250. The mint control interface 240 can include an application programming interface compatible with the content processor 202 to detect the property token 242 at the content processor 202. The mint control interface 240 can include an API distinct from the API corresponding to the request interface 230. For example, the mint control interface 240 can include a security layer to encrypt communication via the mint control interface 240 by the mint control cryptographic key 252.

The NFT transaction processor 250 can execute one or more actions with respect to various cryptographic keys, NFTs, containers, and smart contracts. For example, the NFT transaction processor 250 can modify links, immutable properties, or mutable properties between various containers, NFTs, and smart contracts with various public-private key pairs. The transaction processor 250 can transfer public-private key pairs based on one or more operations of the cryptographic key processor 120, for example. The transaction processor 250 can mint, generate, modify, destroy, deallocate, or any combination thereof, an NFT 220, 222 or 224 or wallet container 210. For example, the system can include processors to generate, by the NFT transaction processor in response to a determination that a modification of the second property of the physical object satisfies a mutability threshold, a second NFT can include the first parameter, a third parameter based on the modification of the second property of the physical object, and the link. For example, the system can include processors to deallocate, by the NFT transaction processor in response to the determination that the modification of the second property of the physical object satisfies the mutability threshold, the NFT. For example, deallocating the NFT can correspond to destroying or dereferencing the NFT. For example, the system can include processors to generate, by the NFT transaction processor, a second NFT can include a third parameter based on a first property of a second physical object, a fourth parameter based on a second property of the second physical object, and a second link with a public and private key pair of the NFT.

The mint control cryptographic key 252 can include a key compatible with and controlled by the data processing system 102 and linked with the content processor 202. Transmission of the mint control cryptographic key 252 can be restricted by the data processing system 102 to within the data processing system 102 or via the mint control interface 240. For example, the system cryptographic key 224 can correspond to a “backup key” or “house key” that must be detected in order to activate processors or decrypt containers of the NFT smart contract 220. Thus, the system cryptographic key 224 can restrict authorization by the NFT smart contract 220 to the data processing system 102 environment.

The permission blockchain 260 can include at least one blockchain including one or more of the blocks 262. The permission blockchain 260 can be linked with one or more content objects 224, secure NFTs 240, and smart contract control structures 210. The permission blockchain 260 can include a blockchain operated and controlled at the data processing system 102. The permission blockchain 260 can include a plurality of blockchains each corresponding to particular aspects of the links associated with the corresponding blockchains. The permission blockchain 260 can include blocks 262, a wallet key link 264, and a mint control key link 266. The blocks 262 can include or store links to one or more objects associated with the blockchain. The wallet key link 264 can include a reference, pointer, or the like, to or between a block among the blocks 262 and the wallet cryptographic key 214 associated with that particular block. The mint control key link 266 can include a reference, pointer, or the like, to or between a block among the blocks 262 and the mint control cryptographic key 252 associated with that particular block.

For example, the system can include processors to receive, by the NFT transaction processor, a second request to generate the second NFT corresponding to the second physical object. For example, the system can include processors to link, by the NFT transaction processor, a first wallet container restricted to a first entity with a second public and private key pair of a second wallet container restricted to a second entity. The system can transfer, in response to a determination that an entity metric corresponding to a state of the first entity satisfies a condition corresponding to a predetermined state of an entity, the NFT to the second public and private key pair. For example, the system can include processors to transfer, by the NFT transaction processor, the NFT to the first wallet container, the first wallet container can include an allocation parameter indicating an allocation of at least a portion of the NFT to the second wallet container.

For example, the computer readable medium can include instructions to cause a processor to detect, by the content processor and based on a feature corresponding to the physical object, a modification of a second property of the physical object. The processor can generate, by the NFT transaction processor in response to a determination that the modification of the second property of the physical object satisfies a mutability threshold, a second NFT can include the first parameter, a third parameter based on the modification of the second property of the physical object, and the link. The processor can deallocate, by the NFT transaction processor in response to the determination that the modification of the second property of the physical object satisfies the mutability threshold, the NFT.

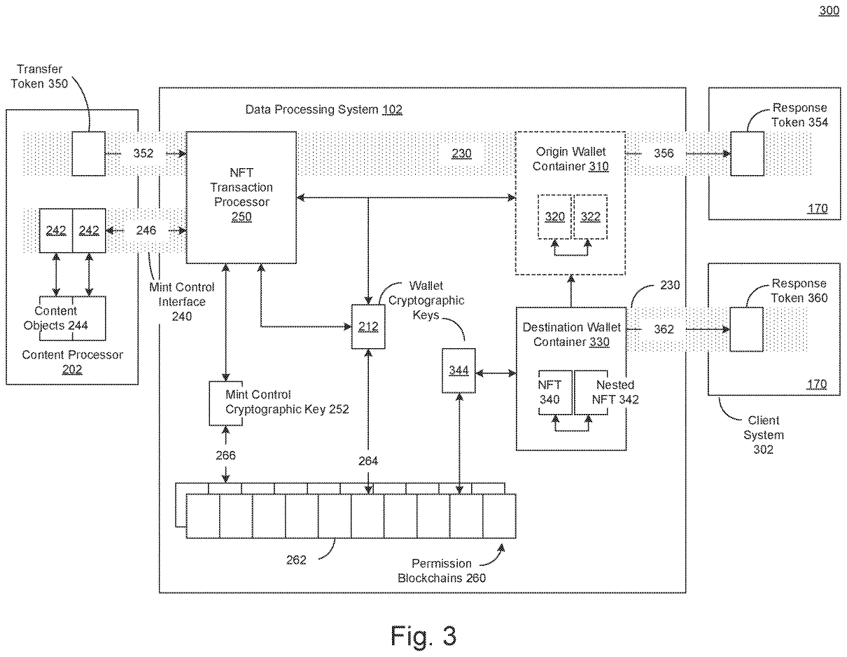

FIG. 3 depicts an example system architecture, in accordance with present implementations. As illustrated by way of example in FIG. 3, an example system architecture 300 can include at least a client system 302, an origin wallet container 310, a destination wallet container 330, a wallet cryptographic key 344, a transfer token 350, a transfer communication 352, a response token 354, a response communication 356, a response token 360, and a response communication 362. The client system 302 can correspond at least partially in one or more of structure and operation to the client system 103, and can be remote from the data processing system 102 and the client system 103. For example, each of the client system 103 and 302 can correspond to respective and distinct mobile devices.

The origin wallet container 310 can correspond at least partially in one or more of structure and operation to the wallet container 210. The origin wallet container 310 can include an origin NFT 320, and an origin nested NFT 322. The origin NFT 320 can correspond at least partially in one or more of structure and operation to the NFT 220. The origin nested NFT 322 can correspond at least partially in one or more of structure and operation to the nested NFT 222. The origin wallet container 310 or the NFT transaction processor 250 can deallocate the origin wallet container 310 in response to a determination or detection by the content processor 202 or the NFT transaction processor 250 that a trigger event to transfer ownership of the wallet container 310 has occurred. For example, a trigger event can correspond to detection of the request token 232 including a wallet transfer indication. The wallet transfer indication can identify or initiate a transfer to a beneficiary identified by the origin wallet container 310.

The destination wallet container 330 can correspond at least partially in one or more of structure and operation to the wallet container 210, and can be linked with a beneficiary account or entity via a wallet cryptographic key 344 corresponding to the beneficiary. The destination wallet container 330 can include a destination NFT 340, and a destination nested NFT 342. The destination NFT 340 can correspond at least partially in one or more of structure and operation to the origin NFT 320. The destination nested NFT 342 can correspond at least partially in one or more of structure and operation to the origin nested NFT 322. For example, the origin wallet container 210 can transfer one or more of the destination NFT 340 and the destination nested NFT 342 to the destination wallet container 330. For example, the NFT transaction processor 250 can deallocate one or more of the origin NFT 320 and the origin nested NFT 322, can mint or generate the destination NFT 340 and the destination nested NFT 342, and can transmit one or more of the destination NFT 340 and the destination nested NFT 342 to the destination wallet container 330. The wallet cryptographic key 344 can correspond at least partially in one or more of structure and operation to the wallet cryptographic key 212, and can be linked with or identify the destination wallet container 330.

The transfer token 350 can identify a wallet container and can identify a trigger event corresponding to a request to transfer the wallet container. For example, the content processor 202 can detect a trigger event and can transmit the transfer token 350 including or referencing the trigger event. For example, the content processor 202 can transmit the transfer token 350 to the NFT transaction processor 250 via the request interface 230. The transfer token 350 can include an encryption layer compatible with the request interface 230. The transfer communication 352 can transmit the transfer token 350 from the content processor 202 to the data processing system 102 or the NFT transaction processor 250.

The response tokens 354 and 360 can respectively include a metric corresponding to an action in response to the trigger event. For example, the response token 354 can include an acknowledgement response that can be presented at the client system 103 by the mobile wallet system 170 of the client system 103. For example, the response token 360 can include an acknowledgement response that can be presented at the client system 302 by the mobile wallet system 170 of the client system 302. The response communications 356 and 362 can communicate the response tokens 354 and 360 via the request interface 230 to the client system 103 and 302.

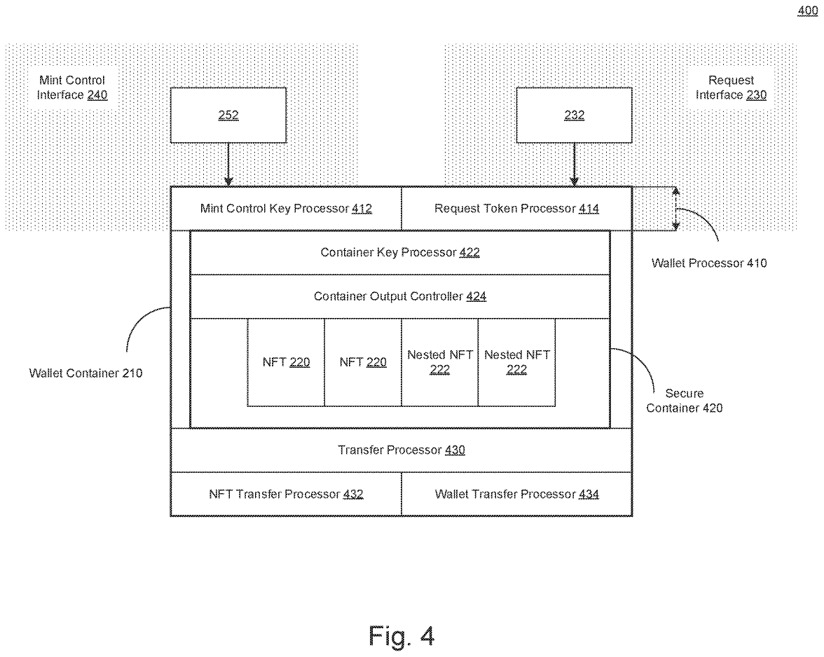

FIG. 4 depicts an example wallet container architecture, in accordance with present implementations. As illustrated by way of example in FIG. 4, an example wallet container architecture 400 can include at least a wallet processor 410, a secure container 420, and a transfer processor 430.

The wallet processor 410 can communicate with and validate various tokens and NFTs. The wallet processor 410 can include one or more interfaces corresponding to an API or a smart contract interface, for example. A smart contract interface can include one or more executable instructions integrated with a smart contract. The smart contract interface can execute instructions at the smart contract or triggered by the smart contract in response to detection of objects or conditions external to the smart contract. The wallet processor 410 can comprise at least a portion of a control structure of the smart contract. The wallet processor 410 can include a mint control key processor 412, and a request token processor 414.

The mint control key processor 412 can detect the presence of the mint control cryptographic key 252, and can determine whether the mint control cryptographic key 252 is compatible with the mint control key processor 412. The mint control key processor 412 can be configured to be compatible with a particular mint control cryptographic key 252 corresponding to a particular content processor 202 of a plurality of content processors 202, or can be generated to be compatible with a particular mint control cryptographic key 252. For example, the mint control key processor 412 can be integrated with or store a hash based on an identification or authorization cryptographic key of a particular content processor 202, and a hash processor operable to generate a hash based on any cryptographic key of a particular content processor 202. For example, the mint control key processor 412 can include a public key or a private key of a key pair of a particular mint control cryptographic key 252, and can authenticate at least a portion of the mint control cryptographic key 252 based on a hash or comparison with the portion of the mint control cryptographic key 252. The mint control key processor 412 can generate a hash in response to detecting the presence of the mint control cryptographic key 252, and can determine whether the mint control cryptographic key 252is compatible with the smart contract control structure, in response generating the hash, by comparing the generated hash with the stored hash. The mint control key processor 412 can include logic to detect a mint control cryptographic key 252passed to it, by, for example, a JSON object or a header argument. The request token processor 414 can detect the request token 232 obtained by the wallet container 210 via the wallet processor 410. The request token processor 414 can detect the request token 232 obtained by the wallet container 210.

The secure container 420 can include a security layer that restrict access to one or more of the NFTs or cryptographic keys. The secure container 420 can include, for example, a security encapsulation that partially or completely encrypts one or more components of the secure container 420. The secure container 420 can include a container key processor 422, and a container output controller 424. The container key processor 422 can detect the presence of a cryptographic key, and can determine whether the cryptographic key is compatible with the secure container 420. The container key processor 422 can obtain the cryptographic key from the request token 232, for example. For example, the private key can be stored entirely within the request token 232. For example, the request key can be stored entirely within the mint control cryptographic key 252 to restrict output from the secure container 422 to tokens corresponding to the content processor 202. The container output controller 424 can selectively transfer at least NFTs from and to the secure container 420 based on a determinations from the container key processor 422. For example, the container output controller 424 can transfer an NFT to the wallet container 310 or 330 in response to a determination that the wallet cryptographic key 212 or 344 is compatible with the container key processor 422 of that container. The secure container 420 can include any number or combination of zero or more NFTs, and is not limited to the examples illustrated herein.

The transfer processor 430 can transfer and modify various NFTs, containers, and wallet objects. The transfer processor 430 can include an NFT transfer processor 432 and a wallet transfer processor 434. The NFT transfer processor 432 can transfer and modify various NFTs. The NFT transfer processor 432 can determine to and initiate a transfer of an NFT 220 or generation of a destination NFT 224, 340 or 342. For example, the NFT transfer processor 432 can obtain the wallet NFT from an external source. For example, an external source can include the wallet container 210 or a source external to the data processing system 102. The NFT transfer processor 432 can insert any NFT into the secure container 420. The wallet transfer processor 434 can transfer and modify various wallet containers. For example, the wallet transfer processor 434 can generate or obtain a cryptographic key pair corresponding to a particular wallet container. The wallet transfer processor 434 can insert the cryptographic key pair corresponding to a particular wallet container into the secure container 420 or a storage region of the wallet transfer processor 434.

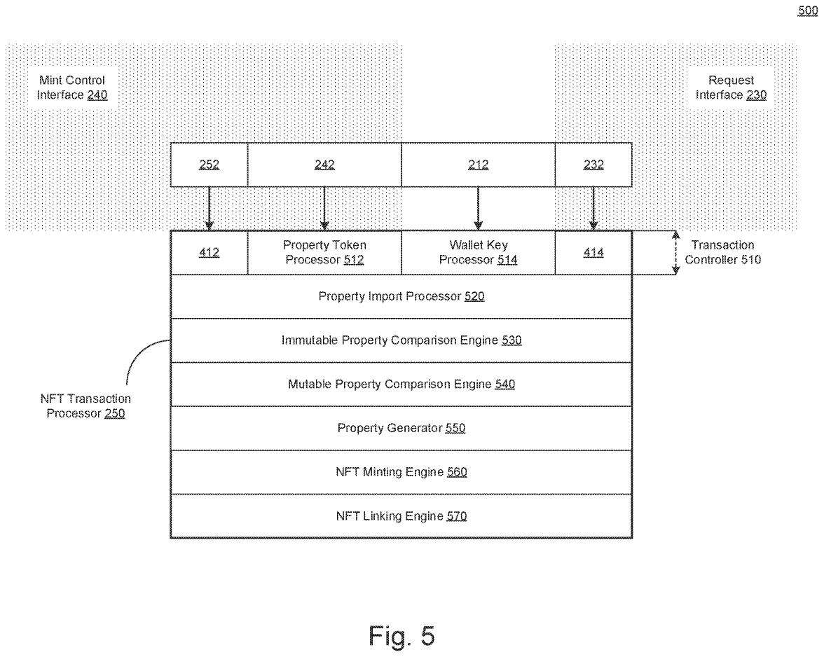

FIG. 5 depicts an example NFT transaction processor architecture, in accordance with present implementations. As illustrated by way of example in FIG. 5, an example NFT transaction processor architecture 500 can include at least a transaction controller 510, a property import processor 520, an immutable property comparison engine 530, a mutable property comparison engine 540, a property generator 550, an NFT minting engine 560, and an NFT linking engine 570.

The transaction controller 510 can detect presence of a token, and can transmit the token to a token processor compatible with that particular token. The transaction controller 510 can include a property token processor 512, and a wallet key processor 514. The property token processor 512 can detect the property token 242 obtained by the NFT transaction processor 250 via the mint control interface 240. The wallet key processor 514 can detect the presence of the wallet cryptographic key 212 or 344, and can determine whether the wallet cryptographic key 212 or 344 is compatible with the wallet key processor 514. The wallet key processor 514 can be configured to be compatible with a particular wallet cryptographic key 212 or 344 corresponding to a particular wallet container 210, 310 or 330, or can be generated to be compatible with a particular wallet container 210, 310 or 330.

The property import processor 520 can identify one or more immutable and mutable properties corresponding to a particular NFT. The property import processor 520 can communicate with the wallet container 210 to identify one or more immutable and mutable properties of an NFT contained within the wallet container 210. For example, the property import processor 520 can transmit a request including or linked with the wallet cryptographic key 212 to the wallet container 210, and can receive one or more immutable and mutable properties for the NFT 220 or the nested NFT 222 via the wallet container 210. For example, the property import processor 520 can receive one or more immutable and mutable properties for the NFT 220 or the nested NFT 222 via the request token 232. The property import processor 520 can obtain one or more metrics corresponding to particular immutable or mutable properties from the content processor 202 via the mint control interface 240. For example, the property import processor 520 can transmit a request via the mint control interface 240 to the content processor 202 to obtain the property token 244 indicating one or more immutable properties or mutable properties of an NFT. The property import processor 244 can extract immutable properties and mutable properties from the property tokens and the NFT, and can extract metrics for the immutable properties and mutable properties from the property tokens and the NFT. The property import processor 520 can transmit the immutable property and the mutable property respectively to the immutable property comparison engine 530 and the immutable property comparison engine 530.

The immutable property comparison engine 530 can TTT detect or determine whether an NFT metric obtained from an immutable property of an NFT matches or corresponds to a detected metric obtained from an immutable property of a property token corresponding to the NFT. For example, the immutable property comparison engine 530 can compare a first set of coordinates corresponding to a property boundary of real estate from the immutable property of the NFT with a second set of coordinates corresponding to a property boundary of real estate from the immutable property of the property token for the NFT. In response to determining a difference between one or more coordinates of the first and second sets of coordinates, the immutable property comparison engine 530 can detect or determine that a material change to the immutable property of the NFT has occurred, and can transmit an indication of the material change to one or more of the property generator 550 and the NFT minting engine 560.

The mutable property comparison engine 540 can detect or determine whether an NFT metric obtained from a mutable property of an NFT matches or corresponds to a detected metric obtained from a mutable property of a property token corresponding to the NFT. For example, the mutable property comparison engine 540 can compare a first photograph of a structure of real estate from the mutable property of the NFT with a second photograph of a structure of real estate from the mutable property of the property token for the NFT. In response to determining a difference between one or more coordinates of the first and second photographs, the immutable property comparison engine 530 can detect or determine that a material change or an immaterial change to the immutable property of the NFT has occurred, and can transmit an indication of the material change or the immaterial change to one or more of the property generator 550 and the NFT minting engine 560. For example, the mutable property comparison engine 540 can detect change in a color of a structure of real estate, and can determine that a change in color an immaterial change based on presence or lack of presence of the change of particular portion of the photograph correpsonding to the color change. For example, the mutable property comparison engine 540 can detect an addition of a structure of real estate, and can determine that the addition of the structure corresponds to a material change based on presence or lack of presence of the change of particular portions of the photograph correpsonding to the addition of the structure.

For example, the immutable property comparison engine 530 and the mutable property comparison engine 540 can compare differences between media content or text data, including but not limited to comparing differences between photographs and database records to identify changes there between.

The property generator 550 can generate one or more immutable properties or mutable properties. The property generator 550 can, for example, generate an immutable property based on content of a property token 242 that identifies an immutable property or a mutable property corresponding to an object. The property generator 550 can, for example, generate an immutable property based on content of a property token 242 that identifies a change of an immutable property or a mutable property corresponding to an object. The property generator 550 can generate or copy at least a portion of immutable or mutable properties of an NFT.

The NFT minting engine 560 can generate an NFT including one or more of an immutable property, a mutable property, and a link. For example, the NFT minting engine 560 can include a security control component configured to block minting or generating an NFT in the absence of detection or determination of presence of the mint control cryptographic key 252 by the mint control key processor 412.

The NFT linking engine 570 can generate an object corresponding to an address to or reference an NFT external to an NFT including the link. For example, the NFT linking engine 570 can generate the NFT 220 with a link to the nested NFT 222. The NFT linking engine 570 can generate a directed link that can indicate a hierarchical relationship between NFTs. For example, the NFT linking engine 570 can generate a directed link including a direction indicator metric to indicate a parent relationship or a child relationship between an ANF including the link and an NFT referenced by the link.

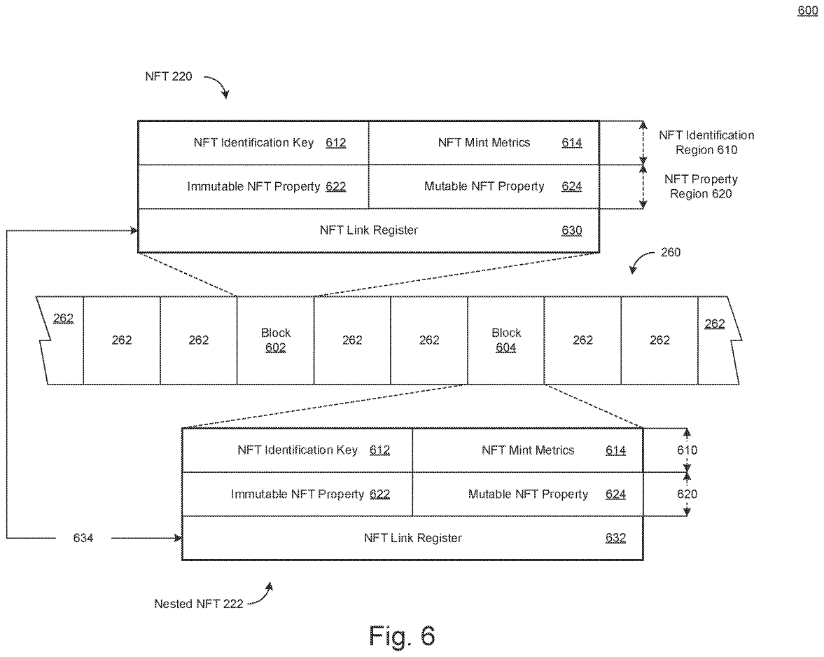

FIG. 6 depicts an example NFT architecture, in accordance with present implementations. As illustrated by way of example in FIG. 6, an example NFT architecture 600 can include at least blocks 602 and 604, an NFT identification region 610, an NFT property region 620, and NFT link registers 630 and 632. The NFT architecture 600 can include but is not limited to the NFTs illustrated by way of example. The blocks 602 and 604 can include references to or identifiers of the NFT 220 and the nested NFT 220, and can correspond at least partially in one or more of structure and operation to the blocks 262.

The NFT identification region 610 can include metrics unique to or correpsonding to a particular NFT. For example, the NFT minting engine 560 can generate or modify the NFT identification region 610 or any component thereof. The NFT identification region 610 can include an NFT identification key 612, and NFT mint metrics 614. The NFT identification key 612 can uniquely identify the NFT. For example, the NFT identification key 612 can include a hash correpsonding to the NFT 220 or the block 602. The NFT mint metrics 614 can store various metrics correpsonding to the minting of the NFT. For example, the NFT mint metrics 614 can include a timestamp correpsonding to the time of minting of the NFT 220, a device identifier or system identifier of the data processing system 102, the content processor 202, the NFT transaction processor 250, the NFT minting engine 560, or any combination thereof involved in generating the NFT 220.

The NFT property region 620 can store various properties corresponding to a content object 244, or a physical object or non-physical object defined by the content object 244. The NFT property region 620 can be generated by the NFT minting engine 560. The NFT property region 620 can include an immutable NFT property 622, and a mutable NFT property 624. The immutable NFT property 622 can include a data region of an NFT configured to store one or more immutable properties corresponding to a content object 244, or a physical object or non-physical object defined by the content object 244. For example, the immutable NFT property 622 can include a first hash, tree structure, database structure, media content object, or any combination thereof, or any reference to any hash, tree structure, data base structure, or any combination thereof external to the NFT.

The mutable NFT property 624 can include a data region of an NFT configured to store one or more mutable properties corresponding to a content object 244, or a physical object or non-physical object defined by the content object 244. For example, the mutable NFT property 624 can include a first hash, tree structure, database structure, media content object, or any combination thereof, or any reference to any hash, tree structure, data base structure, or any combination thereof external to the NFT. For example, the mutable NFT property 624 can include a threshold definition correpsonding to a threshold configured to the particular mutable NFT property 624 and indicating a quantitative or qualitative boundary between a material change and an immaterial change to the mutable NFT property 624. The NFT link registers 630 and 632 can include a data region of an NFT configured to store one or more links between NFTs. The NFT link registers 630 and 632 can include addresses or references to NFTs and can include directional indicators corresponding to the relationships between the NFTs. The NFT link 634 can link various NFTs. For example, the NFT link 634 can link NFT 220 with the nested NFT 222.

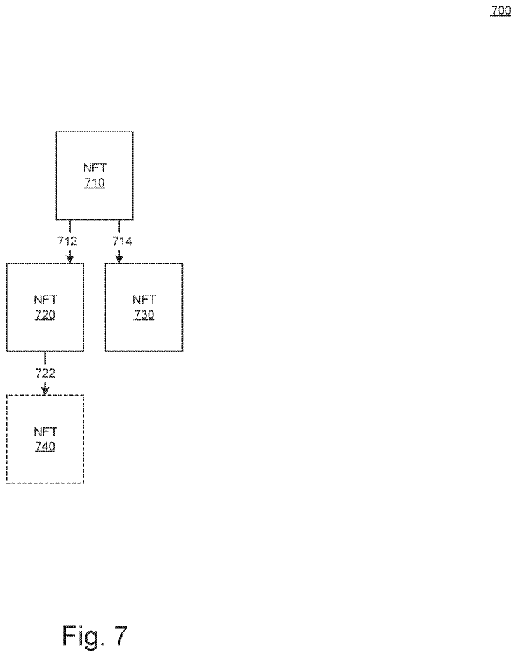

FIG. 7 depicts an example NFT nest architecture, in accordance with present implementations. As illustrated by way of example in FIG. 7, an example NFT nest architecture 700 can include at least an NFT 710, NFTs 720 and 730, an NFT link 722, and an NFT 740. Each of the NFTs 710, 720, 730 and 740 can correspond at least partially in one or more of structure and operation to the NFT 220 but are not limited thereto.

The NFT 710 can correspond to a root or parent NFT. For example, the NFT 710 can correspond to a real property. For example, The NFT 710 can include NFT links 712 and 714. The NFT links 712 and 714 can include directional links respectively to the NFTs 720 and 730, indicating that the NFTs 720 and 730 are children or dependencies of the NFT 710. The NFTs 720 and 730 can correspond to a dependent or child NFT. For example, the NFTs 720 and 730 can respectively correspond to a main home and an accessory dwelling of the real property. The NFT link 722 can include a directional links to the NFT 740, indicating that the NFT 740 is a child or dependent of the NFT 720. The NFT 740 can correspond to a dependent or child NFT that has been deallocated. For example, the NFT 740 can correspond to a loan secured against the main home or the real property, and can be deallocated in response to a loan payoff event.

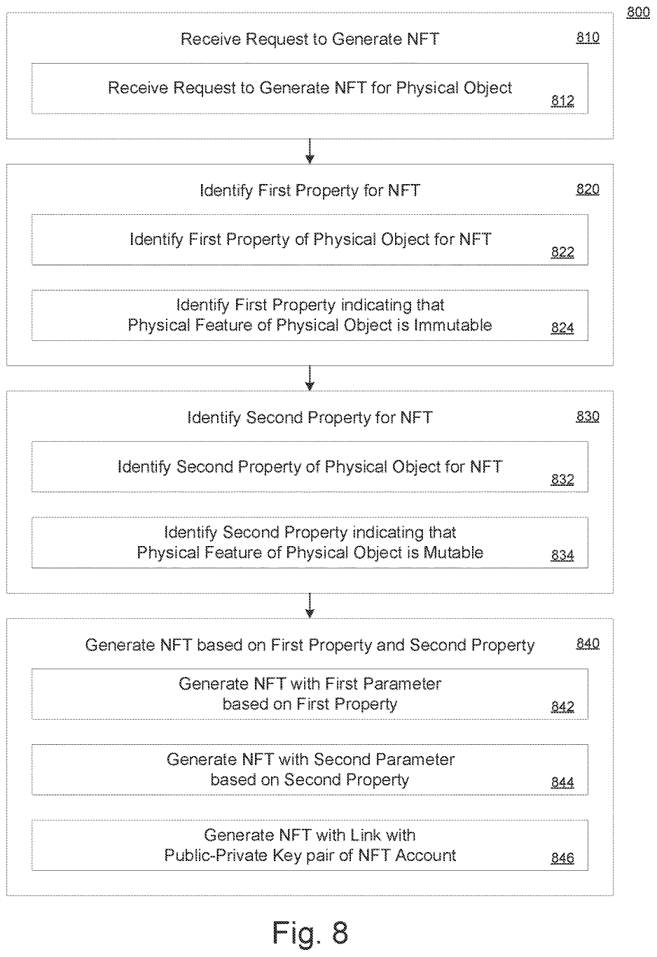

FIG. 8 depicts an example method of generating NFT corresponding to one or more properties, in accordance with present implementations. At least one of the system 100 and the device 200 can perform method 800. At 810, the method 800 can receive a request to generate an NFT. At 812, the method 800 can receive a request to generate an NFT corresponding to a physical object. For example, the method can include receiving, by the NFT transaction processor, a second request to generate the second NFT corresponding to the second physical object.

At 820, the method 800 can identify a first property corresponding to an NFT. At 822, the method 800 can identify a first property corresponding to a physical object linked with an NFT. At 824, the method 800 can identify a first property indicating that a physical feature of a physical object is immutable. For example, the method can include identifying, by the content processor, the first property of the second physical object indicating that a first physical feature of the second physical object is immutable. The method can include identifying, by the content processor, the second property of the second physical object indicating that a second physical feature of the second physical object is mutable. At 830, the method 800 can identify a second property corresponding to an NFT. At 832, the method 800 can identify a second corresponding to a physical object linked with an NFT. For example, the method can include detecting, by the content processor and based on a feature corresponding to the physical object, the modification of the second property of the physical object. At 834, the method 800 can identify a second property indicating that a physical feature of a physical object is mutable.

At 840, the method 800 can generate an NFT based on one or more of a first property and a second property. At 842, the method 800 can generate an NFT with a first parameter based on a first property. For example, the method can include generating, by the NFT transaction processor in response to a determination that a modification of the second property of the physical object satisfies a mutability threshold, a second NFT that can include the first parameter, a third parameter based on the modification of the second property of the physical object, and the link. At 844, the method 800 can generate an NFT with a second parameter based on a second property. At 846, the method 800 can generate an NFT with a link with a public-private key pair of an NFT account. For example, the method can include linking, by the NFT transaction processor, a first wallet container restricted to a first entity with a second public and private key pair of a second wallet container restricted to a second entity. The method can include transferring, in response to a determination that an entity metric corresponding to a state of the first entity satisfies a condition corresponding to a predetermined state of an entity, the NFT to the second public and private key pair. For example, the method can include transferring, by the NFT transaction processor, the NFT to the first wallet container, the first wallet container can include an allocation parameter indicating an allocation of at least a portion of the NFT to the second wallet container.

For example, the method 800 can include deallocating, by the NFT transaction processor in response to the determination that the modification of the second property of the physical object satisfies the mutability threshold, the NFT. For example, the method 800 can include generating, by the NFT transaction processor, a second NFT that can include a third parameter based on a first property of a second physical object, a fourth parameter based on a second property of the second physical object, and a second link with a public and private key pair of the NFT.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

1. A method to maintain a non-fungible token (NFT) based on a physical object, the method comprising:
receiving, by an NFT transaction processor from an origin user, a request to generate an NFT corresponding to the physical object comprising a physical property, the physical property comprising a property boundary of real estate and a structure of the real estate within the property boundary;
in response to receiving the request, generating, by the NFT transaction processor, an origin NFT corresponding to the physical object;
generating, by the NFT transaction processor, a nested NFT corresponding to a non-physical object identifying parameters of a mortgage associated with the physical property;
generating, by the NFT transaction processor, an origin directed link indicating hierarchical relationship between the origin NFT and the nested NFT, the origin directed link comprising an origin direction indicator metric indicating dependency of the nested NFT on the origin NFT, wherein the origin directed link is stored in a link register of the origin NFT as an address or reference to the nested NFT and as the origin direction indicator metric;
transmitting, by the NFT transaction processor, the origin NFT and the nested NFT to an origin wallet container associated with the origin user, wherein the origin wallet container comprises an encrypted secure container that restricts access to the origin NFT and the nested NFT based on compatibility of an origin wallet cryptographic key with the encrypted secure container;
comparing, by the NFT transaction processor, coordinates of the property boundary and colors of the structure of the real estate within a first photograph of the physical property associated with a first time value and a second photograph of the physical property associated with a second time value later in time from the first time value;
in response to detecting a difference between a first set of coordinates of the property boundary in the first photograph and a second set of coordinates of the property boundary in the second photograph, identifying, by a content processor, an immutable property of the physical object indicating that a first physical feature of the physical object is immutable;
in response to detecting a difference between a first color of the structure of the real estate in the first photograph and a second color of the structure of the real estate in the second photograph, identifying, by the content processor, a mutable property of the physical object indicating that a second physical feature of the physical object is mutable;
generating, by the NFT transaction processor, a destination NFT corresponding to the physical object, the destination NFT comprising an immutable parameter based on the immutable property of the physical object and a mutable parameter based on the mutable property of the physical object;
generating, by the NFT transaction processor, a destination nested NFT corresponding to the non-physical object identifying parameters of the mortgage associated with the physical property;
generating, by the NFT transaction processor, a destination directed link indicating hierarchical relationship between the destination NFT and the destination nested NFT, the destination directed link comprising a destination direction indicator metric indicating dependency of the destination nested NFT on the destination NFT, wherein the destination directed link is stored in a link register of the destination NFT as an address or reference to the destination nested NFT and as the destination direction indicator metric;
in response to receiving a transfer token based on a trigger event, determining that a destination wallet cryptographic key associated with a destination wallet container is compatible with an encrypted secure container of the destination wallet container;
in response to determining that the destination wallet cryptographic key is compatible with the encrypted secure container of the destination wallet container, transferring, by the NFT transaction processor, the destination NFT and the destination nested NFT to the encrypted secure container of the destination wallet container associated with a destination user; and
deallocating, by the NFT transaction processor, the origin NFT and the nested NFT from the origin wallet container by removing or dereferencing the origin NFT and the nested NFT from the encrypted secure container of the origin wallet container.

2. The method of claim 1, further comprising:
generating, by the NFT transaction processor in response to a determination that a modification of the mutable property of the physical object satisfies a mutability threshold, a second NFT including the immutable parameter and a third parameter based on the modification of the mutable property of the physical object.

3. The method of claim 2, further comprising:
detecting, by the content processor and based on a feature corresponding to the physical object, the modification of the mutable property of the physical object.

4. The method of claim 2, further comprising:
deallocating, by the NFT transaction processor in response to the determination that the modification of the mutable property of the physical object satisfies the mutability threshold, the origin NFT.

5. The method of claim 1, further comprising:
generating, by the NFT transaction processor, a second NFT including a third parameter based on a first property of a second physical object, a fourth parameter based on a second property of the second physical object, and a second link with a public and private key pair of the origin NFT.

6. The method of claim 5, further comprising:
identifying, by the content processor, the first property of the second physical object indicating that a first physical feature of the second physical object is immutable; and
identifying, by the content processor, the second property of the second physical object indicating that a second physical feature of the second physical object is mutable.

7. The method of claim 6, further comprising:
receiving, by the NFT transaction processor, a second request to generate the second NFT corresponding to the second physical object.

8. The method of claim 1, further comprising:
linking, by the NFT transaction processor, a first wallet container restricted to a first entity with a second public and private key pair of a second wallet container restricted to a second entity; and
transferring, in response to a determination that an entity metric corresponding to a state of the first entity satisfies a condition corresponding to a predetermined state of an entity, the origin NFT to the second public and private key pair.

9. The method of claim 8, wherein the first wallet container includes an allocation parameter indicating an allocation of at least a portion of the origin NFT to the second wallet container.

10. A system to maintain a non-fungible token (NFT) based on a physical object, the system comprising:
memory and a plurality of processors comprising an NFT transaction processor and a content processor to:
receive, by the NFT transaction processor from an origin user, a request to generate an NFT corresponding to the physical object comprising a physical property, the physical property comprising a property boundary of real estate and a structure of the real estate within the property boundary;
in response to receiving the request, generate, by the NFT transaction processor, an origin NFT corresponding to the physical object;
generate, by the NFT transaction processor, a nested NFT corresponding to a non-physical object identifying parameters of a mortgage associated with the physical property;
generate, by the NFT transaction processor, an origin directed link indicating hierarchical relationship between the origin NFT and the nested NFT, the origin directed link comprising an origin direction indicator metric indicating dependency of the nested NFT on the origin NFT, wherein the origin directed link is stored in a link register of the origin NFT as an address or reference to the nested NFT and as the origin direction indicator metric;
transmit, by the NFT transaction processor, the origin NFT and the nested NFT to an origin wallet container associated with the origin user, wherein the origin wallet container comprises an encrypted secure container that restricts access to the origin NFT and the nested NFT based on compatibility of an origin wallet cryptographic key with the encrypted secure container;
compare, by the NFT transaction processor, coordinates of the property boundary and colors of the structure of the real estate within a first photograph of the physical property associated with a first time value and a second photograph of the physical property associated with a second time value later in time from the first time value;
in response to detecting a difference between a first set of coordinates of the property boundary in the first photograph and a second set of coordinates of the property boundary in the second photograph, identify, by the content processor, an immutable property of the physical object indicating that a first physical feature of the physical object is immutable;
in response to detecting a difference between a first color of the structure of the real estate in the first photograph and a second color of the structure of the real estate in the second photograph, identify, by the content processor, a mutable property of the physical object indicating that a second physical feature of the physical object is mutable;
generate, by the NFT transaction processor, a destination NFT corresponding to the physical object, the destination NFT comprising an immutable parameter based on the immutable property of the physical object and a mutable parameter based on the mutable property of the physical object;
generate, by the NFT transaction processor, a destination nested NFT corresponding to the non-physical object identifying parameters of the mortgage associated with the physical property;
generate, by the NFT transaction processor, a destination directed link indicating hierarchical relationship between the destination NFT and the destination nested NFT, the destination directed link comprising a destination direction indicator metric indicating dependency of the destination nested NFT on the destination NFT, wherein the destination directed link is stored in a link register of the destination NFT as an address or reference to the destination nested NFT and as the destination direction indicator metric;
in response to receiving a transfer token based on a trigger event, determine, by the NFT transaction processor, that a destination wallet cryptographic key associated with a destination wallet container is compatible with an encrypted secure container of the destination wallet container;
in response to determining that the destination wallet cryptographic key is compatible with the encrypted secure container of the destination wallet container, transfer, by the NFT transaction processor, the destination NFT and the destination nested NFT to the encrypted secure container of the destination wallet container associated with a destination user; and
deallocate, by the NFT transaction processor, the origin NFT and the nested NFT from the origin wallet container by removing or dereferencing the origin NFT and the nested NFT from the encrypted secure container of the origin wallet container.

11. The system of claim 10, the processors to:
generate, by the NFT transaction processor in response to a determination that a modification of the mutable property of the physical object satisfies a mutability threshold, a second NFT including the immutable parameter and a third parameter based on the modification of the mutable property of the physical object.

12. The system of claim 11, the processors to:
detect, by the content processor and based on a feature corresponding to the physical object, the modification of the mutable property of the physical object.

13. The system of claim 11, the processors to:
deallocate, by the NFT transaction processor in response to the determination that the modification of the mutable property of the physical object satisfies the mutability threshold, the origin NFT.

14. The system of claim 10, the processors to:
generate, by the NFT transaction processor, a second NFT including a third parameter based on a first property of a second physical object, a fourth parameter based on a second property of the second physical object, and a second link with a public and private key pair of the origin NFT.

15. The system of claim 14, the processors to:
identify, by the content processor, the first property of the second physical object indicating that a first physical feature of the second physical object is immutable; and
identify, by the content processor, the second property of the second physical object indicating that a second physical feature of the second physical object is mutable.

16. The system of claim 15, the processors to:
receive, by the NFT transaction processor, a second request to generate the second NFT corresponding to the second physical object.

17. The system of claim 10, the processors to:
link, by the NFT transaction processor, a first wallet container restricted to a first entity with a second public and private key pair of a second wallet container restricted to a second entity; and
transfer, in response to a determination that an entity metric corresponding to a state of the first entity satisfies a condition corresponding to a predetermined state of an entity, the origin NFT to the second public and private key pair.

18. The system of claim 17, wherein the first wallet container includes an allocation parameter indicating an allocation of at least a portion of the origin NFT to the second wallet container.

19. A non-transitory computer readable medium including one or more instructions stored thereon and executable by a processor to:
receive, from an origin user, a request to generate an NFT corresponding to a physical object comprising a physical property, the physical property comprising a property boundary of real estate and a structure of the real estate within the property boundary;
in response to receiving the request, generate an origin NFT corresponding to the physical object;
generate a nested NFT corresponding to a non-physical object identifying parameters of a mortgage associated with the physical property;
generate an origin directed link indicating hierarchical relationship between the origin NFT and the nested NFT, the origin directed link comprising an origin direction indicator metric indicating dependency of the nested NFT on the origin NFT, wherein the origin directed link is stored in a link register of the origin NFT as an address or reference to the nested NFT and as the origin direction indicator metric;
transmit the origin NFT and the nested NFT to an origin wallet container associated with the origin user, wherein the origin wallet container comprises an encrypted secure container that restricts access to the origin NFT and the nested NFT based on compatibility of an origin wallet cryptographic key with the encrypted secure container;
compare coordinates of the property boundary and colors of the structure of the real estate within a first photograph of the physical property associated with a first time value and a second photograph of the physical property associated with a second time value later in time from the first time value;
in response to detecting a difference between a first set of coordinates of the property boundary in the first photograph and a second set of coordinates of the property boundary in the second photograph, identify an immutable property of the physical object indicating that a first physical feature of the physical object is immutable;
in response to detecting a difference between a first color of the structure of the real estate in the first photograph and a second color of the structure of the real estate in the second photograph, identify mutable property of the physical object indicating that a second physical feature of the physical object is mutable;
generate a destination NFT corresponding to the physical object, the destination NFT comprising an immutable parameter based on the immutable property of the physical object and a mutable parameter based on the mutable property of the physical object;
generate a destination nested NFT corresponding to the non-physical object identifying parameters of the mortgage associated with the physical property;
generate a destination directed link indicating hierarchical relationship between the destination NFT and the destination nested NFT, the destination directed link comprising a destination direction indicator metric indicating dependency of the destination nested NFT on the destination NFT, wherein the destination directed link is stored in a link register of the destination NFT as an address or reference to the destination nested NFT and as the destination direction indicator metric;
in response to receiving a transfer token based on a trigger event, determine that a destination wallet cryptographic key associated with a destination wallet container is compatible with an encrypted secure container of the destination wallet container;
in response to determining that the destination wallet cryptographic key is compatible with the encrypted secure container of the destination wallet container, transfer the destination NFT and the destination nested NFT to the encrypted secure container of the destination wallet container associated with a destination user; and
deallocate the origin NFT and the nested NFT from the origin wallet container by removing or dereferencing the origin NFT and the nested NFT from the encrypted secure container of the origin wallet container.

20. The non-transitory computer readable medium of claim 19, the one or more instructions further comprising:
in response to a determination that a modification of the mutable property of the physical object satisfies a mutability threshold, generate a second NFT including the immutable parameter and a third parameter based on the modification of the mutable property of the physical object; and
in response to the determination that the modification of the mutable property of the physical object satisfies the mutability threshold, deallocate the origin NFT.
